(19) United States
(12) Patent Application Publication
(10) Pub. No.: US 2026/0226856 A1
(43) Pub. Date: Aug. 6, 2026

(54) Tank with Replaceable Filter Unit, e.g. for Diesel Exhaust Fluid

(71) Applicant: Perkins Engines Company Limited, Peterborough (GB)

(72) Inventors: Tristan Green, Nottingham (GB); Siddharth Subhash Gharpure, Peterborough (GB)

(21) Appl. No.: 19/147,764

(22) PCT Filed: Jan. 11, 2024
(86) PCT No.: PCT/EP2024/025015

§ 371 Date: Jul. 14, 2025

(30) Foreign Application Priority Data
Jan. 16, 2023 (GB) 2300628.1

(51) Int. Cl. F01N 3/20

(52) U.S. Cl. CPC F01N 3/206; F01N 2610/01; F01N 2610/1406; F01N 2610/1426

(57) ABSTRACT

An assembly includes a tank with a bottom mounted outlet unit and a tubular filter unit which is installed and removed independently of the outlet unit via a service aperture in the top of the tank. The filter unit has a bottom opening which is sealingly closed by engagement of the filter unit with the tank and outlet unit sub-assembly. The tank may be mounted on a vehicle to supply DEF to a diesel exhaust aftertreatment system.

### TECHNICAL FIELD

This disclosure relates to tanks, particularly for supplying an exhaust aftertreatment system with diesel exhaust fluid (referred to herein as DEF), and particularly for commercial work vehicles for use on off-road worksites.

### BACKGROUND

Diesel powered work vehicles such as wheeled or tracked excavators, loaders, and other construction vehicles used on off-road worksites are exposed to dusty conditions which can result in contamination of the DEF tank used to supply the exhaust aftertreatment system. To ensure a clean supply of DEF to the system, it is known to protect the header unit that draws DEF from the tank within a tubular filter.

For example, U.S. Pat. No. 11,331,605 discloses a DEF tank having a sensor unit including a heater and DEF supply and return lines, arranged within a replaceable, tubular filter. The sensor unit is inserted and withdrawn through an aperture in the top of the tank. The filter may be inserted and withdrawn through an opposing aperture in the bottom of the tank.

U.S. Pat. No. 11,268,419 B2 and U.S. Pat. No. 9,468,875 B2 disclose DEF tanks having a header assembly arranged within a tubular filter, and mounted via an aperture in the top of the tank.

In such arrangements, the DEF is drawn from the inlet in the sensor unit or header unit by a DEF pump mounted on the vehicle chassis, which supplies the fluid to the DEF injector(s) in the aftertreatment system, and typically also returns unused DEF to the tank. Often the header unit will include a heater that extends through the depth of the liquid in the tank, typically carrying a flow of engine coolant, and a level sensing arrangement that extends alongside the heater. Such level sensing arrangements are designed to cope with vigorous sloshing of the DEF in the tank.

In contrast to off-road vehicles, vehicles that are designed mainly for use on the public highway are often fitted with a DEF tank that has an integral, non-removable pump and filter unit, which may also include an electric heater and a submerged, ultrasonic level sensor for sensing the level of DEF in the tank. Such units are expected to last for the life of the vehicle without maintenance under typical operating conditions which are less demanding than in an off-road work environment. The pump and filter unit is often permanently fixed to the tank. For example, both the tank and the body of the pump and filter unit may be made from plastics material, and the body of the pump and filter unit may be welded to the wall of the tank.

Compared with the conventional off-road assembly, this integrated assembly reduces manufacturing cost, but disadvantageously requires replacement of the entire tank and pump and filter unit assembly in the event that the filter becomes clogged.

### SUMMARY OF THE DISCLOSURE

In accordance with the present disclosure there is provided an assembly as defined in claim 1. Optional features are defined in the dependent claims.

The novel assembly includes a tank sub-assembly and a filter unit.

The tank sub-assembly includes a tank and an outlet unit. The tank defines an interior space for holding a liquid, and has a service aperture formed in an upper wall of the tank. The outlet unit is mounted at a lower wall of the tank and has a liquid inlet and a liquid outlet, and is configured to supply liquid from the tank, via the liquid inlet to the liquid outlet.

The filter unit has a liquid permeable, tubular wall surrounding an interior space of the filter unit, and is arranged in a use position within the tank so that the interior space of the filter unit occupies a first portion of the interior space of the tank, and the tubular wall forms a barrier between the first portion of the interior space of the tank, and a second portion of the interior space of the tank exterior to the filter unit. The liquid inlet is arranged in fluid communication with the first portion of the interior space of the tank in the use position of the filter unit.

The filter unit has a bottom opening, which is formed at a lower end of the filter unit when considered in its use position and communicates with the interior space of the filter unit.

The filter unit is releasably, sealingly engaged with the tank sub-assembly to sealingly close the bottom opening in the use position of the filter unit, and is installable and removable, independently of the outlet unit, via the service aperture.

### BRIEF DESCRIPTION OF THE DRAWINGS

Further features and advantages will be evident from the illustrative embodiments which will now be described, purely by way of example and without limitation to the scope of the claims, and with reference to the accompanying drawings, in which:

FIG. 1 shows a first assembly in accordance with a first embodiment of the disclosure, with the tank partially cut away revealing the filter unit in its use position;

FIG. 2 shows the tank sub-assembly of the first assembly;

FIG. 3 shows the filter unit of the first assembly;

FIG. 4 shows a second assembly in accordance with a second embodiment of the disclosure, with the tank partially cut away revealing the filter unit in its use position;

FIG. 5 shows the tank sub-assembly of the second assembly;

FIG. 6 shows the filter unit of the second assembly; and

FIG. 7 shows a work vehicle including an assembly in accordance with an embodiment of the disclosure.

Reference numerals and characters that appear in more than one of the figures indicate the same or corresponding elements in each of them.

### DETAILED DESCRIPTION

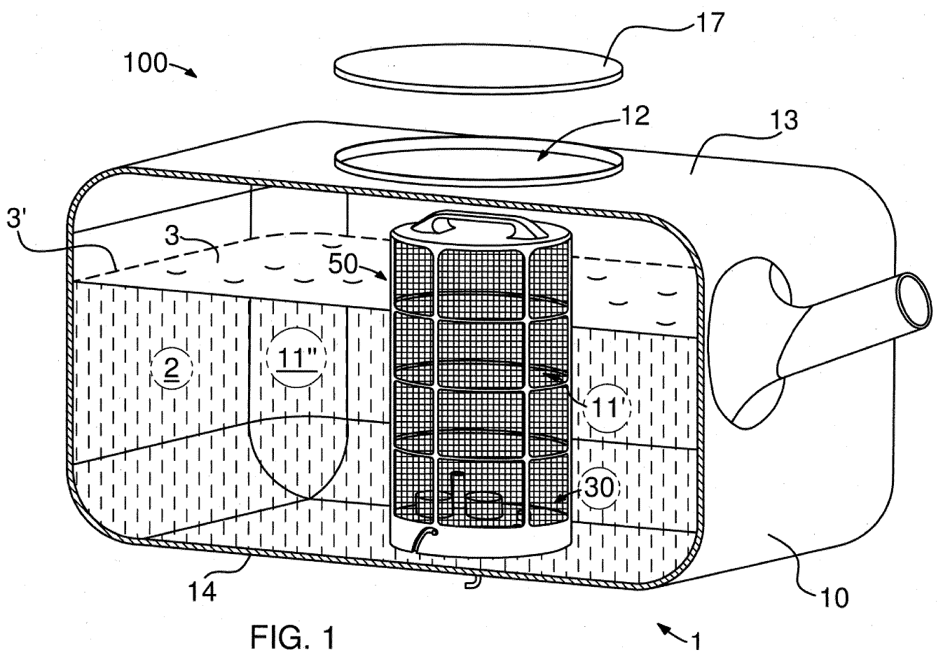

Referring to FIGS. 1-3, a first assembly 100 includes a tank sub-assembly 1 and a filter unit 50.

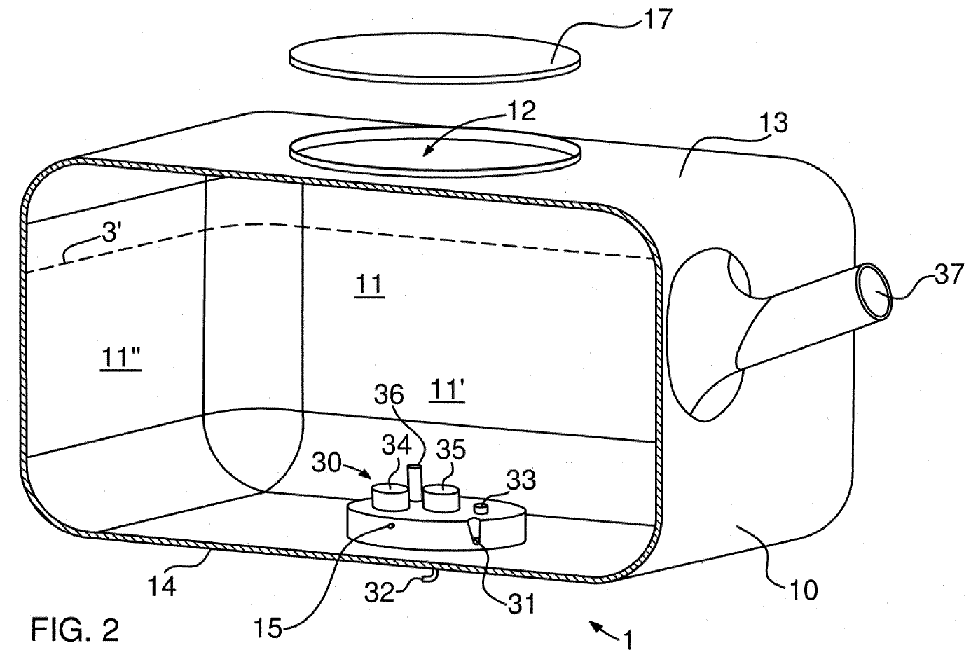

Referring particularly to FIG. 2, the tank sub-assembly 1 includes a tank 10 and an outlet unit 30. The tank 10 defines an interior space 11 for holding a liquid 2 and has a service aperture 12 formed in an upper wall 13 of the tank 10. The liquid may be a diesel exhaust fluid, referred to herein as DEF, for treatment of diesel exhaust gas.

Typically the DEF is an aqueous solution of urea acting as a reductant in a selective catalytic reduction unit of a vehicle exhaust system. By way of example, FIG. 7 shows how the assembly 100 can be incorporated into a vehicle 101 including a diesel engine 102, an exhaust aftertreatment system 103 for treating exhaust gas 104 emitted by the engine 102. The outlet unit 30 is configured to supply the liquid 2 from the tank 10 to the exhaust aftertreatment system 103 of the vehicle, which may be a wheeled or tracked work vehicle for use in off-road conditions. It could be for example a tipping truck, an excavator, or a wheel loader as shown.

The outlet unit 30 is mounted at a lower wall 14 of the tank 10 and has a liquid inlet 31 and a liquid outlet 32. It is configured to supply the DEF or other liquid 2 from the tank 10, via the liquid inlet 31 to the liquid outlet 32. Where the liquid is DEF, the liquid outlet 32 will be connected to a liquid injector or other outlet in the exhaust aftertreatment system 103.

The outlet unit 30 may be permanently fixed to the tank 10, for example, by welding or otherwise bonding the body of the outlet unit to the wall of the tank. In such arrangements, the outlet unit may be regarded as a non-serviceable component, so that both the tank and the outlet unit must be replaced together as a single assembly in the event of failure. The tank may be made from any material suitable (or having a coating suitable) for the DEF or other contained liquid. For example, it may be made from metal or plastics material. Where the tank and the body of the outlet unit 30 are both made from plastics material, the outlet unit may be welded to the tank, for example, by ultrasonic welding.

As illustrated in the second assembly, where the tank 10 is formed from plastics material, the base of the tank may be locally thickened to define a boss 18, formed integrally with the lower wall 14 of the tank, which incorporates an engaging feature 15 for engaging the filter unit 50 to mechanically connect the filter unit to the tank sub-assembly 1, as further discussed below. The boss provides stiffness to react the torque or other forces applied during installation of the filter unit 50.

As illustrated in both the first and second assemblies, the outlet unit 30 may extend via the bottom opening 53 into the interior space 52 of the filter unit 50 in the use position of the filter unit 50. Usefully, this elevates the functional parts of the outlet unit above any debris that may collect at the base of the tank, and provides a compact assembly that is easier to install since only the outlet 32 (and other electrical and/or fluid connections, not shown) may project below the bottom wall of the tank.

The outlet unit 30 may include a pump 34 and an outlet unit filter 35 and/or a heater 36 for heating the DEF or other liquid 2 in the tank. Such units are commercially available and well known in the art. In such arrangements, the outlet unit filter 35 is configured to filter the liquid 2 supplied from the tank 10 via the pump 34 which urges the liquid 2 from the inlet 31 via the filter 35 and the outlet 32 to its point of use, for example, an injector in the exhaust aftertreatment system 103. The outlet unit filter 35 may be an integral part of the outlet unit 30, which is to say, the filter 35 may not be removable from the outlet unit without destroying the outlet unit.

The outlet unit 30 may include an ultrasonic level sensor 33 which is operable to generate an ultrasonic signal to sense a liquid surface level 3 in the tank 10. In the use position of the filter unit 50, the tubular wall 51 extends above a maximum liquid surface level 3′ in the tank 10 (which may be defined, for example, by a level gauge or by the position of the filler inlet 37.) The level sensor 33 is arranged to sense the liquid surface level 3 within the interior space 52 of the filter unit 50 in its use position. As known in the art, the level sensor 33 may sense the level of the liquid in the internal space within the filter based on the time of flight of the ultrasonic signal that is emitted from the submerged sensor 33 and then detected again at the sensor 33 after being reflected back from the liquid surface.

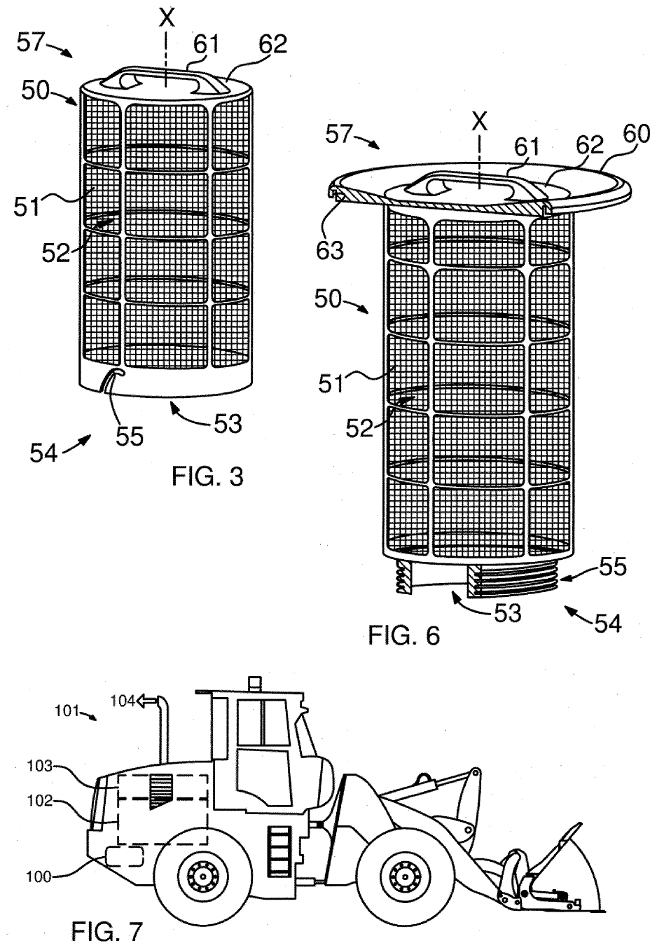

Referring particularly to FIG. 3, the filter unit 50 has a liquid permeable, tubular wall 51 surrounding an interior space 52 of the filter unit 50. The tubular wall 51 may be cylindrical as illustrated, forming a surface of rotation about a central length axis X. It may comprise a liquid permeable filter material or membrane supported by a framework. The filter material may include two or more layers of material which may be connected together. The filter material may have a combination of two or more different structures, for example, to form a pleated cylindrical filter. The filter unit 50 has a bottom opening 53 formed at a lower end 54 of the filter unit 50 when considered in its use position, which communicates with the interior space 52.

The filter material is illustrated as diaphanous, purely for ease of illustration so we can see the outlet unit 30 inside the filter; it will be understood of course that the filter material may be as dense as required to intercept the designed particle size, and so in practice may be opaque as is conventional in the art. In order to accommodate flexing of the tank in service, the filter material may be flexible so that the length of the filter unit can adapt to accommodate variations in the distance between the upper and lower walls of the tank, and/or so that the tubular wall can flex to accommodate relative movement between the upper and lower ends of the filter unit out of the plane of its length axis X to accommodate relative displacement between the top and bottom structures of the tank.

Referring now particularly to FIG. 1, the filter unit 50 is arranged in its use position within the tank 10 so that the interior space 52 of the filter unit 50 occupies a first portion 11′ of the interior space 11 of the tank 10, and the tubular wall 51 forms a barrier between the first portion 11′ of the interior space 11 of the tank 10, and a second portion 11″ of the interior space 11 of the tank 10 exterior to the filter unit 50.

The liquid inlet 31 is arranged in fluid communication with the first portion 11′ of the interior space 11 of the tank 10, which is to say, with the interior space 52 of the filter unit 50 in its use position, so that the liquid is drawn by the pump 34 (if provided) from the second portion 11″ of the interior space, through the tubular wall 51 into the interior space 52 of the filter unit, and then from the interior space 52 of the filter unit 50 into the inlet 31.

In its use position, the filter unit 50 is releasably, sealingly engaged with the tank sub-assembly 1 to sealingly close the bottom opening 53, which is to say, to close the bottom opening so that the liquid in the second portion 11″ of the interior space of the tank, exterior to the filter unit, cannot enter the inlet 31 without first passing through the tubular wall 51.

An engaging surface formed on the filter unit 50 at the bottom opening 53 may engage a corresponding engaging surface of the tank sub-assembly 1 (e.g. of the tank 10 or of the outlet unit 30) to mechanically fix the filter in its use position and/or to sealingly close the bottom opening 53. The first and second embodiments illustrate two alternative arrangements of this type having respective engaging features 55, 15, as further discussed below. Alternatively or additionally, a seal or seals (not shown) forming part of either or both of the filter unit 50 and the tank sub-assembly 1 may be provided to seal the bottom opening 53 while the respective engaging surfaces accomplish the mechanical connection.

The filter unit 50 is installable and removable, independently of the outlet unit 30, via the service aperture 12, and so can be changed for a new filter unit simply by detaching it from the tank sub-assembly 1 and lifting it out of the tank through the service aperture 12, without removing or disturbing the outlet unit 30 which as discussed above may be permanently fixed in the tank.

Conveniently, the filter unit 50 may be releasably, sealingly engageable with the tank sub-assembly 1 to sealingly close the bottom opening 53, by rotation of the filter unit 50 about a length axis X of the tubular wall 51.

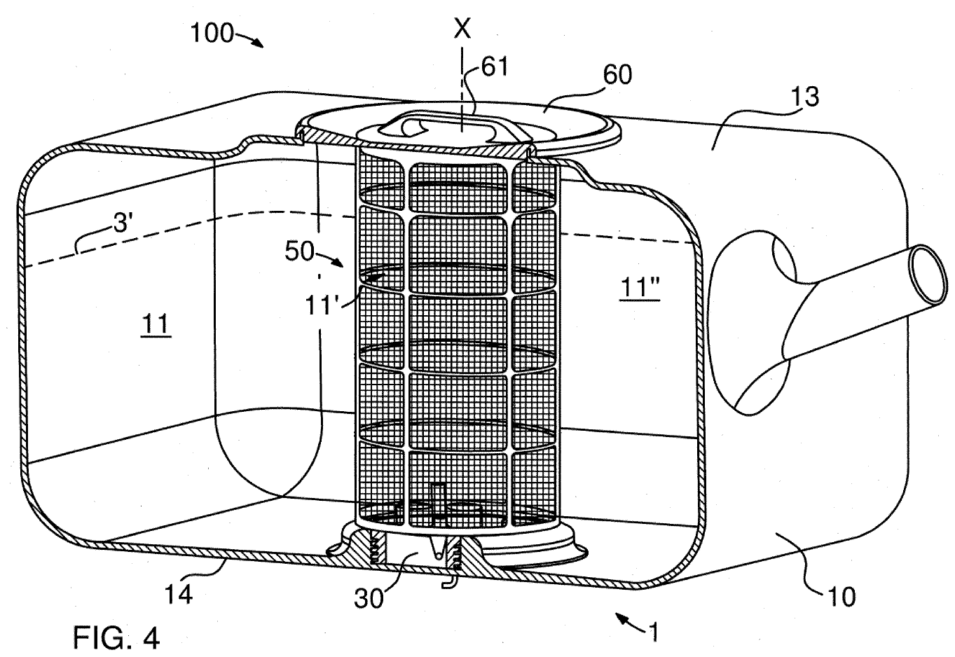

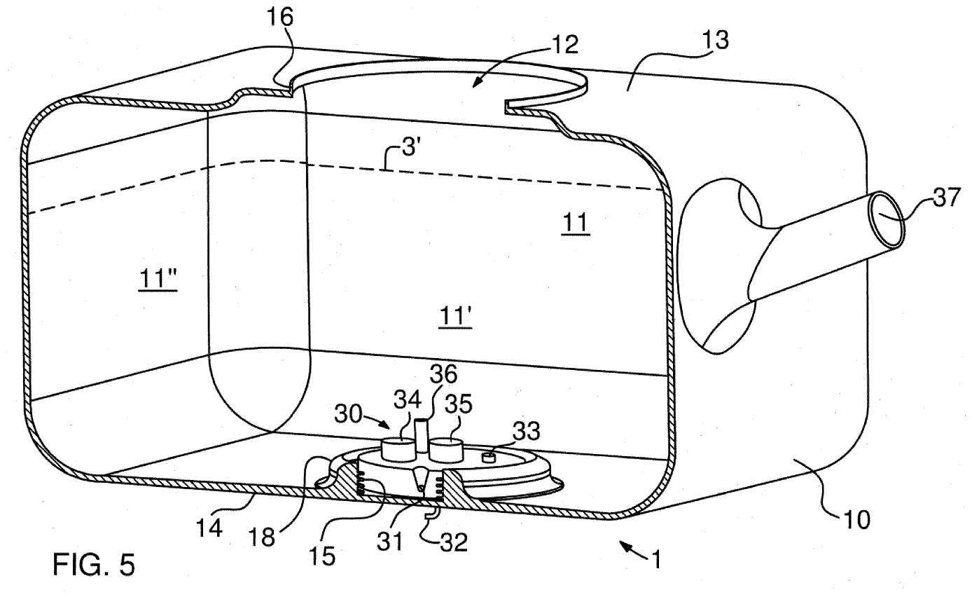

FIGS. 4-6 illustrate a second assembly which generally is similar to the first assembly, having the same features described above, but with some differences as will now be discussed.

As illustrated in both the first and second assemblies, the filter unit 50 may include a handle 61 and an upper end wall 62 which are arranged at the upper end 57 of the filter unit 50 opposite the lower end 54. The upper end wall 62 bounds the interior space 52 of the filter unit 50, which may open only via the bottom opening 53 which is sealingly closed in its use position. The handle 61 is graspable to manipulate the filter unit 50 during installation and removal.

As illustrated in the first embodiment (FIGS. 1-3) , the filter unit 50 including the handle 61 may be entirely contained within the tank 10 in its use position. In such arrangements, the service aperture 12 may be closed by a separate lid 17 with suitable fixings (not shown).

As illustrated in the second embodiment (FIGS. 4-6) , the filter unit 50 may be exposed at its upper end 57 in its use position, so that the handle is accessible from outside the tank 10.

Referring now to the second embodiment of FIGS. 4-6, the filter unit 50 may include a closure plate 60 which is arranged at the upper end 57 of the filter unit 50 opposite the lower end 54. The closure plate 60 is releasably, sealingly engaged with the tank 10 to sealingly close the service aperture 12 in the use position of the filter unit 50.

In such arrangements, as illustrated, the filter unit 50 may include a handle 61 that is connected to the closure plate 60 and exposed exteriorly of the tank 10 in the use position of the filter unit 50. The handle 61 is graspable to manipulate the filter unit 50 during installation and removal.

The closure plate 60 may be sealingly engageable with the tank 10 to sealingly close the service aperture 12 by rotation of the filter unit 50 about a length axis X of the tubular wall 51.

The closure plate 60 and the filter unit 50 may be simultaneously, sealingly engageable, respectively with the tank 10 to sealingly close the service aperture 12, and with the tank sub-assembly 1 to sealingly close the bottom opening 53.

As illustrated, the closure plate 60 and the filter unit 50 may be simultaneously, sealingly engageable, respectively with the tank 10 to sealingly close the service aperture 12, and with the tank sub-assembly 1 to sealingly close the bottom opening 53, by rotation of the filter unit 50 about the length axis X of the tubular wall 51.

Referring now to both the first and second embodiments (FIG. 1-3 and FIGS. 4-6) , the lower end 54 of the filter unit 50 may include a first engaging feature 55, wherein the tank sub-assembly 1 includes a corresponding, second engaging feature 15. The first and second engaging features 55, 15 are configured to engage together to constrain the filter unit 50 for movement simultaneously in axial translation along the length axis X of the tubular wall 51, and in rotation about the length axis X of the tubular wall 51, towards the use position.

In the first embodiment, the first engaging feature 55 is formed as a guide surface or surfaces, e.g. of a slot as illustrated, while the second engaging feature 15 is formed as an engaging surface, e.g. of a protuberance as illustrated. A corresponding protuberance (not shown) may be provided in a position diametrically opposite the illustrated protuberance, to fit another, corresponding slot (not shown). The or each protuberance fits into the respective slot so that the features 55, 15 cooperate to form a bayonet connection, with the respective surfaces slidingly engaged together to guide the filter unit 50 both axially and in rotation. As illustrated, the bayonet connection may be arranged to provide a slight over-centre action whereby the filter unit 50 is locked into place when sufficient torque is applied to the handle 61 to cause slight flexure of the filter unit 50 or of a resilient O-ring or other seal (not shown) that is provided to seal the bottom opening 53, allowing the protuberance to move past the uppermost part of the slot as the filter unit 50 rotates fully to the use position.

As illustrated, the bottom opening 53 may be sealingly closed by sliding abutment between the respective, radially confronting surfaces of the lower end portion of the filter unit 50 and the outlet unit 30, or by a separate seal (not shown) which may be compressed by movement of the filter unit 50 to its use position.

In alternative arrangements the respective bayonet features could be reversed, to provide the slot or other guide surface(s) on the tank sub-assembly 1 and the protuberance(s) on the filter unit 50.

In the second embodiment, the first and second engaging features 55, 15 are configured as cooperating screw threads which extend helically about the central axis X of the filter unit 50. The bottom opening 53 may be sealingly closed by sliding abutment between the respective screw threads, or by sliding abutment between the respective, radially confronting surfaces of the lower end portion of the filter unit 50 and the outlet unit 30 which extends inside the lower end of the filter unit 50 in its use position, or by a separate seal (not shown) which may be compressed by movement of the filter unit 50 to its use position.

As also illustrated by the second embodiment (FIGS. 4-6) , the closure plate 60 may include a first sealing surface 63, wherein the tank 10 includes a second sealing surface 16, at least one of the first and second sealing surfaces 63, 16 being cylindrical. Each of the first and second sealing surfaces 63, 16 is a surface of rotation about the length axis X of the tubular wall 51 when considered in the use position of the filter unit 50. The first and second sealing surfaces 63, 16 are sealingly engageable together to sealingly close the service aperture 12.

Advantageously, this decouples rotation between the first and second sealing surfaces 63, 16 from the axial movement of the filter unit 50, allowing relative rotation between the sealing surfaces irrespective of their relative positions along the length axis X, so that the assembly is tolerant of dimensional variation arising for example from flexing of the tank walls. In the illustrated embodiment, the first sealing surface 63 is a formed in an annular slot in the lower surface of the closure plate 60, while the second sealing surface 16 is formed as a cylindrical rim surrounding the service aperture 12. In alternative arrangements (not shown) a respective one of the sealing surfaces could be formed as an o-ring or other resilient seal.

### INDUSTRIAL APPLICABILITY

The filter unit of the novel assembly filters out debris before it reaches the outlet unit, and so prolongs the life of the outlet unit, including the pump and integral filter where provided. This makes it possible to use conventional outlet units designed for on-road vehicles, also in work vehicles for off-road use.

In the novel assembly, the outlet unit (including its integral filter) may be expected to last for its design lifespan equal to the life of the vehicle, even when used in off-road conditions. This means that the outlet unit need not be replaceable, and so can be permanently fixed to the bottom of the tank which is often the optimal location for both function and ease of manufacture. The outlet unit may be permanently bonded, e.g. welded (e.g. ultrasonically welded) to the tank, which obviates any risk of leakage through a defective seal.

By arranging the filter unit to be removable and replaceable independently of the outlet unit via a sealed service aperture at the top of the tank, the risk of leakage from the seal is reduced (since it is above the liquid level in the tank), and the filter unit is easier to replace because it is not necessary to drain the tank or remove the outlet unit.

When a new filter unit is installed, the bottom opening allows liquid already present in the tank to flow into the interior space within the filter unit, while trapped air inside the new filter unit (being less dense than liquid) escapes quickly through the permeable tubular wall as it is introduced into the tank. This makes it possible to install the new filter unit quickly and easily while the tank is full of liquid, without causing the liquid to overflow from the tank, even where the filter unit is relatively voluminous and so has an advantageously large surface area for better filtration performance.

The bayonet or screwthread connection at the lower end of the filter unit can provide a strong connection while allowing the filter unit to be changed with minimal effort, even without the use of tools by virtue of a graspable handle.

Maintenance can be further simplified by the integral outlet plate which closes the maintenance aperture without additional components. By arranging for the outlet plate to seal the maintenance opening via a cylindrical sealing surface (which unlike the lower end connection does not constrain the filter unit axially), the bottom opening and maintenance aperture can be sealingly closed simultaneously while providing tolerance to accommodate variation in the distance between the upper and lower walls of the tank as the tank flexes.

By arranging for the outlet unit to extend inside the first filter unit in use, all of the functional wetted parts of the outlet unit are protected by the filter unit. This also ensures that the inlet is positioned within the interior space of the first filter unit, even when the inlet is formed as a simple aperture in the body of the outlet unit. This allows the first filter unit to be used in tanks that have an outlet unit of conventional design, avoiding the need to adapt the inlet position.

Advantageously, where the outlet unit includes an ultrasonic level sensor, the filter extends above the maximum level of liquid in the tank and so does not interfere with the operation of the level sensor. Further advantageously, the filter will dampen sloshing of the liquid within the tank and also suppresses bubbling of the liquid by breaking the larger bubbles that may form. This provides a relatively more constant ultrasonic level signal by sensing the relatively more constant level of liquid in the internal space within the filter, so that ultrasonic level sensing can be used instead of other level sensing arrangements commonly used for off-road vehicles where the expected off-road site conditions may cause violent agitation of the tank in use.

The novel assembly can be used with DEF or with liquids other than DEF. In either case, the tank may be mounted on a vehicle, particularly a work vehicle for off-road use.

In summary, an assembly includes a tank with a bottom mounted outlet unit and a tubular filter unit which is installed and removed independently of the outlet unit via a service aperture in the top of the tank. The filter unit has a bottom opening which is sealingly closed by engagement of the filter unit with the tank and outlet unit sub-assembly. The tank may be mounted on a vehicle to supply DEF to a diesel exhaust aftertreatment system.

Many further adaptations are possible within the scope of the claims.

In the claims, reference numerals and characters are provided in parentheses, purely for ease of reference, and are not to be construed as limiting features.

1. An assembly including:
a tank sub-assembly, and
a filter unit;
the tank sub-assembly including a tank and an outlet unit;
the tank defining an interior space for holding a liquid, and having a service aperture formed in an upper wall of the tank;
the outlet unit being mounted at a lower wall of the tank having a liquid inlet and a liquid outlet, and configured to supply liquid from the tank, via the liquid inlet to the liquid outlet;
the filter unit having a liquid permeable, tubular wall surrounding an interior space of the filter unit;
the filter unit being arranged in a use position within the tank so that the interior space of the filter unit occupies a first portion of the interior space of the tank, and the tubular wall forms a barrier between the first portion of the interior space of the tank, and a second portion of the interior space of the tank exterior to the filter unit;
the liquid inlet being arranged in fluid communication with the first portion of the interior space of the tank in the use position of the filter unit;
the filter unit having a bottom opening the bottom opening being formed at a lower end of the filter unit when considered in its use position, and communicating with the interior space of the filter unit;
the filter unit being releasably, sealingly engaged with the tank sub-assembly to sealingly close the bottom opening in the use position of the filter unit;
the filter unit being installable and removable, independently of the outlet unit, via the service aperture.

2. An assembly according to claim 1, wherein the outlet unit includes a level sensor operable to generate an ultrasonic signal to sense a liquid surface level in the tank; and the tubular wall (51) extends above a maximum liquid surface level in the tank, wherein the level sensor is arranged to sense the liquid surface level within the interior space of the filter unit,

3. An assembly according to claim 1, wherein the filter unit is releasably, sealingly engageable with the tank sub-assembly to sealingly close the bottom opening, by rotation of the filter unit about a length axis (X) of the tubular wall

4. An assembly according to claim 1, wherein the filter unit includes a handle and an upper end wall the handle and the upper end wall being arranged at an upper end of the filter unit opposite the lower end; the upper end wall bounding the interior space of the filter unit; the handle being graspable to manipulate the filter unit during installation and removal.

5. An assembly according to claim 1, wherein the filter unit includes a closure plate the closure plate being arranged at an upper end of the filter unit opposite the lower end the closure plate being releasably, sealingly engaged with the tank to sealingly close the service aperture in the use position of the filter unit.

6. An assembly according to claim 5, wherein the filter unit includes a handle connected to the closure plate, the handle being exposed exteriorly of the tank in the use position of the filter unit and graspable to manipulate the filter unit during installation and removal.

7. An assembly according to claim 5, wherein the closure plate is sealingly engageable with the tank to sealingly close the service aperture by rotation of the filter unit about a length axis (X) of the tubular wall,

8. An assembly according to claim 5, wherein the closure plate and the filter unit are simultaneously, sealingly engageable, respectively with the tank to sealingly close the service aperture, and with the tank sub-assembly to sealingly close the bottom opening.

9. An assembly according to claim 5, wherein the closure plate and the filter unit are simultaneously, sealingly engageable, respectively with the tank to sealingly close the service aperture and with the tank sub-assembly to sealingly close the bottom opening, by rotation of the filter unit about a length axis (X) of the tubular wall.

10. An assembly according to claim 9, wherein the lower end of the filter unit includes a first engaging feature and the tank sub-assembly includes a second engaging feature the first and second engaging features being configured to engage together to constrain the filter unit for movement simultaneously in axial translation along the length axis (X) of the tubular wall, and in rotation about the length axis (X) of the tubular wall, towards the use position.

11. An assembly according to claim 10, wherein the closure plate includes a first sealing surface, and the tank includes a second sealing surface; at least one of the first and second sealing surfaces being cylindrical; each of the first and second sealing surfaces being a surface of rotation about the length axis (X) of the tubular wall when considered in the use position of the filter unit; the first and second sealing surfaces being sealingly engageable together to sealingly close the service aperture.

12. An assembly according to claim 1, wherein the outlet unit extends via the bottom opening into the interior space of the filter unit in the use position of the filter unit.

13. An assembly according to claim 1, wherein the outlet unit is permanently fixed to the tank.

14. An assembly according to claim 1, wherein the outlet unit includes a pump and an outlet unit filter the outlet unit filter being configured to filter the liquid supplied from the tank via the pump.

15. An assembly according to claim 1, wherein the tubular wall is cylindrical.

16. A vehicle including a diesel engine an exhaust aftertreatment system for treating exhaust gas emitted by the engine, and an assembly as defined in any preceding claim, wherein the outlet unit is configured to supply the liquid from the tank to the exhaust aftertreatment system.
